(19) United States
(12) Patent Application Publication
(10) Pub. No.: US 2016/0215732 A1
(43) Pub. Date: Jul. 28, 2016

(54) BYPASS DUCT HEAT EXCHANGER PLACEMENT

(71) Applicant: UNITED TECHNOLOGIES CORPORATION, Farmington, CT (US)

(72) Inventor: Robert E. Malecki, Storrs, CT (US)

(21) Appl. No.: 15/024,254

(22) PCT Filed: Jul. 30, 2014
(86) PCT No.: PCT/US2014/048856

§ 371 Date: Mar. 23, 2016

Related U.S. Application Data
(60) Provisional application No. 61/881,533, filed on Sep. 24, 2013.

(51) Int. Cl. F02K 3/115; F02C 7/14

(52) U.S. Cl. CPC F02K 3/115; F02C 7/14

(57) ABSTRACT

A bypass duct for a gas turbine engine includes as an inner surface, an intermediate case, an inner fixed structure (IFS), and a heat exchanger outlet mounted to the outer surface of the intermediate case or the forward portion of the IFS. The heat exchanger outlet is oriented to bathe the surface of the bypass duct case downstream of the heat exchanger outlet with low momentum heat exchanger exhaust to reduce skin friction losses for the bypass duct.

### RELATED APPLICATIONS

This application claims the benefit of and priority to U.S. Provisional Patent Application No. 61/881,533 filed Sep. 24, 2013, the contents of which are incorporated herein by reference in their entirety.

### BACKGROUND OF THE INVENTION

1. Field of the Invention

The present disclosure relates to bypass ducts, and more particularly to bypass ducts for turbofan engines, for example.

2. Description of Related Art

A gas turbine engine typically includes a compressor, a combustor, and a turbine. In the case of a turbofan, the engine also includes a fan. Air entering the compressor is compressed and delivered into the combustor where it is mixed with fuel and ignited to generate a high-speed exhaust gas flow. The high-speed exhaust gas flow expands through the turbine to drive the compressor and the fan.

The fan drives air through a bypass duct. The ratio of flow through the bypass duct versus through the compressor and turbine is called the bypass ratio. To improve overall engine performance, there is a trend toward larger and larger bypass ratios. For example, in a geared turbo fan (GTF) engine, a gearing system is used to connect the driving shaft to the fan, so the fan can rotate at a different speed from the turbine driving the fan. One aspect of this type of engine is a larger bypass ratio than previous turbofan engines. As bypass ratio increases, increased flow through the fan and bypass duct improves overall engine performance.

Such conventional methods and systems have generally been considered satisfactory for their intended purpose. However, for large bypass ratio engines including GTF engines, the impact of losses in the bypass duct are significantly greater than for previous turbofan engines, thus there is a need in the art for systems and methods that allow for improved flow efficiency in fans and bypass ducts. There also remains a need in the art for such systems and methods that are easy to make and use. The present disclosure provides a solution for these problems.

### SUMMARY OF THE INVENTION

A bypass duct component for a gas turbine engine includes a heat exchanger outlet configured to be mounted to a bypass duct, wherein the heat exchanger outlet is configured to bathe a bypass duct surface downstream of the heat exchanger outlet with heat exchanger exhaust to reduce skin friction losses for the bypass duct.

In certain embodiments, the heat exchanger outlet is configured to extend around a portion the bypass duct circumferentially. It is contemplated that the heat exchanger outlet is configured to extend around up to 360° of the bypass duct circumferentially.

In certain embodiments, an inner fixed structure (IFS) is included that is a portion of a bypass duct, wherein the heat exchanger outlet is mounted to a forward portion of the inner fixed structure. The heat exchanger outlet faces aft along the inner fixed structure. It is also contemplated that an inner fixed structure (IFS) can include an intermediate case, wherein the heat exchanger outlet is mounted to the intermediate case. The heat exchanger outlet can include a series of circumferentially spaced apart cooling fins configured to extend radially outward from a surface of the inner fixed structure.

A gas turbine engine includes a bypass duct component as described above and a heat exchanger in fluid communication with the heat exchanger outlet. The heat exchanger can be operatively connected to cool oil for an electrical generator. In certain embodiments, the heat exchanger is a first heat exchanger wherein the gas turbine engine further includes a second heat exchanger in fluid communication with the heat exchanger outlet. The first and second heat exchangers can both be in fluid communication with the heat exchanger outlet to exhaust heat exchanger exhaust. The first and second heat exchangers are each operatively connected to cool separate engine components. In certain embodiments, for example, the first heat exchanger is operatively connected to cool oil for an electrical generator, and the second heat exchanger is operatively connected to cool engine oil. It is also contemplated that one of the first and second heat exchangers can be operatively connected to cool engine oil for a geared turbo fan transmission gearbox.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic cross-sectional side elevation view of an exemplary embodiment of a gas turbine engine constructed in accordance with the present disclosure, showing the bypass duct;

FIG. 2 is a schematic cross-sectional side elevation view of the bypass duct of FIG. 1, showing a heat exchanger with an outlet oriented to bathe the surface of the bypass duct, or inner fixed structure (IFS), with heat exchanger exhaust to reduce skin friction losses for the surface of the bypass duct;

FIG. 3 is a schematic cross-sectional end elevation view of the bypass duct case of FIG. 2, showing the heat exchanger outlet extending around a portion of the circumference of the engine intermediate case; and

FIG. 4 is a schematic cross-sectional end elevation view of a portion of another exemplary embodiment of a bypass duct in accordance with the present disclosure, showing a heat exchanger outlet in the form of a set of radially extending fins extending from the outer surface of the intermediate case.

### DETAILED DESCRIPTION OF THE PREFERRED EMBODIMENTS

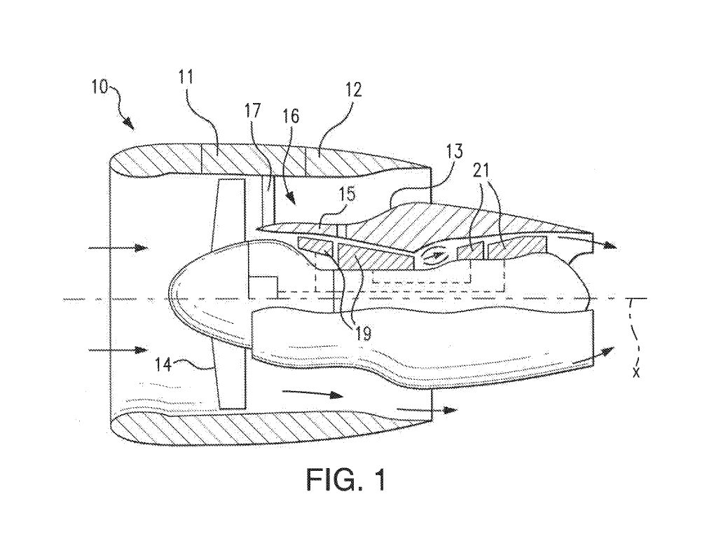

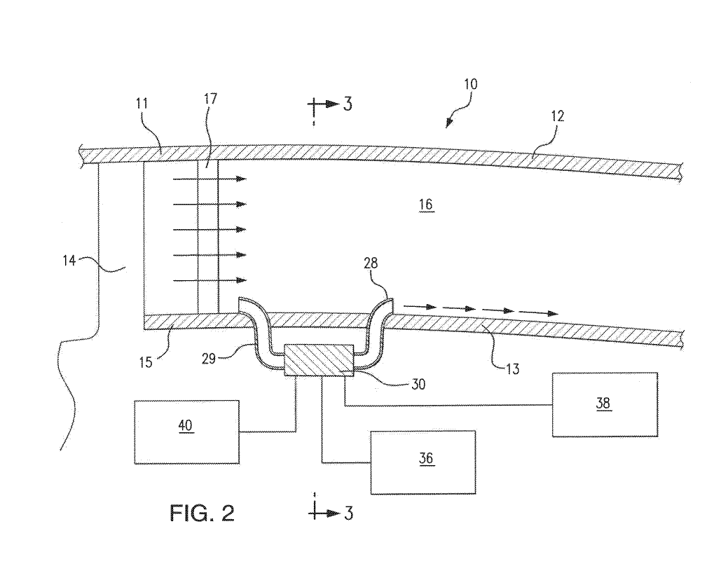

Reference will now be made to the drawings wherein like reference numerals identify similar structural features or aspects of the subject disclosure. For purposes of explanation and illustration, and not limitation, a partial view of an exemplary embodiment of a gas turbine engine in accordance with the disclosure is shown in FIG. 1 and is designated generally by reference character 10. Other embodiments of gas turbine engines in accordance with the disclosure, or aspects thereof, are provided in FIGS. 2-4, as will be described. The systems and methods described herein can be used to reduce skin friction losses in turbofan bypass ducts, for example.

Gas turbine engine 10 is a turbofan, and includes a fan 14, a compressor 19, and a turbine 21 which is configured to drive the compressor 19 and fan 14 around axis x. Fan 14 supplies air to compressor 19, however a large portion of the air from fan 14 passes through bypass duct 16 to provide thrust without passing through compressor 19 or turbine 21. The bypass duct 16 includes the ducting downstream of the fan 14, and the ducting between the engine and fan nozzle exit in the nacelle. Bypass duct 16 is defined between the fan case 11 and intermediate case 15 in the engine, and fan duct outer wall 12 and an inner fixed structure (IFS) 13 in the nacelle. The inner fixed structure (IFS) 13 is an the inner surface of the bypass duct 16 in the nacelle. The fan exit guide vanes 17 connect the fan case 11 and intermediate case 15. Various other aspects of gas turbine engines not explained herein are readily appreciated by those skilled in the art.

As part of the thermal management system for the engine gearbox, and electrical generators powered by the engine, one or more heat exchangers are typically located under the inner surface of the bypass duct 16 to cool the oil used to cool the gearboxes and generators, for example. These heat exchangers draw air from bypass duct 16 to cool the oil. This cooling air is typically exhausted at the aft end of the bypass duct 16, just upstream of the fan nozzle. In the systems of this disclosure, the cooling air is exhausted in the forward portion of bypass duct 16, e.g., to bathe the inner fixed structure (IFS) 13 with this low momentum flow and reduce friction losses in the bypass duct.

Referring now to FIG. 2, the heat exchanger 30 is mounted underneath, i.e. inside, inner fixed structure (IFS) 13, but could also be located within intermediate case 15 or any other suitable location. Heat exchanger outlet 28 is mounted to the inner fixed structure (IFS) 13, but could be mounted to intermediate case 15, or to both intermediate case 15 and inner fixed structure (IFS) 13. Bypass air can enter inlet 29, pass through the heat exchanger 30, and then be exhausted from heat exchanger outlet 28. The heat exchanger outlet 28 is oriented to bathe the radially outer surface of inner fixed structure (IFS) 13, which is also the radially inner surface of bypass duct 16, with heat exchanger exhaust, indicated by the small flow arrows in FIG. 2. The heat exchanger exhaust has relatively the low momentum, as compared to the main flow from fan 14 through bypass duct 16, which flow is indicated by the large flow arrows in FIG. 2.

Skin friction loss in a flow over a surface, such as the surface of inner fixed structure (IFS) 13, is proportional to the velocity gradient du/dy, where u is the flow velocity as a function of y, the height above the surface. The greater the velocity gradient du/dy at the surface, the greater the skin friction loss will be in the flow. By exhausting heat exchanger exhaust air over the inner fixed structure (IFS) 13, the surface is bathed in the heat exchanger exhaust air that has a significantly lower scrubbing velocity than the main fan driven air in bypass duct 16. The lower air velocity flow along the surface lowers the velocity gradient du/dy at the surface of inner fixed structure (IFS) 13, and therefore reduces the skin friction loss for the overall flow through bypass duct 16. This effect can be increased by increasing the circumferential extent of heat exchanger outlet 28 to bathe as much of the inner fixed structure (IFS) 13 as possible.

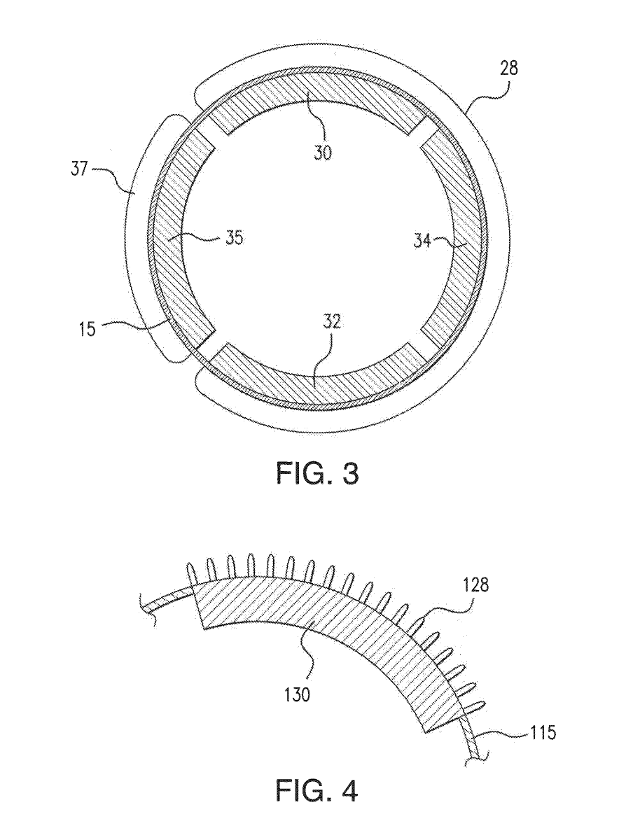

As shown in FIG. 3, heat exchanger outlet 28 extends around a portion of the inner fixed structure (IFS) 13 or intermediate case 15 circumferentially. For example, the heat exchanger outlet 28 can extend to up to 360° of the inner fixed structure (IFS) 13 or intermediate case 15 circumferentially. FIG. 4 shows another exemplary embodiment of a heat exchanger outlet 128 that can provide much the same effect as heat exchanger outlet 28 described above. Heat exchanger outlet 128 includes a series of circumferentially spaced apart cooling fins extending radially outward from the outer surface of the intermediate case 115. Heat from heat exchanger 130 is conducted outward to the fins of heat exchanger outlet 128. As cool fan air passes through the fins, it is both slowed down by the obstruction presented by the fins, as well as being heated up by convective heat exchange with the fins. The result is the air from heat exchanger outlet 128 bathes the outer surface of intermediate case 115 with heat exchanger exhaust much as described above, and the skin friction loss in the bypass duct 16 is reduced. Those skilled in the art will readily appreciate that the heat exchanger outlet embodiments disclosed herein are exemplary, and that any other suitable type of heat exchanger outlet can be used without departing from the scope of this disclosure.

Referring again to FIGS. 1 and 2, gas turbine engine 10 includes a heat exchanger 30 in fluid communication with the heat exchanger outlet 28. A second heat exchanger 32 can also be included in fluid communication with the same heat exchanger outlet 28. First and second heat exchangers 30 and 32 are each operatively connected to cool separate engine components. For example, the first heat exchanger 30 can be operatively connected to cool oil for an electrical generator 36 (shown schematically in FIG. 2), and the second heat exchanger 32 can be operatively connected to cool engine oil from reservoir 38 (indicated schematically in FIG. 2). As another example, one of the first and second heat exchangers can be operatively connected to cool gear oil for a geared turbo fan transmission 40 (shown schematically in FIG. 2), or a third heat exchanger 34 can be included for cooling transmission 40. As shown in FIG. 3, the heat exchangers can be circumferentially segmented, or they can be segmented any other suitable way. In FIG. 3, heat exchanger outlet 28 extends around a majority of the circumference of intermediate case 15, and exhausts cooling air from heat exchangers 30, 32, and 34. An additional heat exchanger 35 and corresponding heat exchanger outlet 37 are also included to substantially bathe the entire circumference of the intermediate duct 15 and inner fixed structure (13) with heat exchanger exhaust. It is also contemplated that heat exchanger outlets 28 and 37 could be combined into a single heat exchanger outlet extending around the full duct circumference. It is also contemplated that the heat exchangers can all be combined into a single heat exchanger that services the various components being cooled. It should be noted that heat exchangers 30 and 32 are both positioned within the intermediate case 15, or underneath the forward portion of the inner fixed structure (IFS) 13, and both are positioned forward of the respective engine components connected to be cooled thereby. Moving heat exchangers forward relative to the heat exchanger positions in traditional engines, and correspondingly moving the heat exchanger outlet 28 forward, increases the amount of heat exchanger exhaust that can bathe the inner fixed structure (IFS) 13. Combining the exhaust from multiple heat exchangers, or combining the multiple heat exchangers together, allows for increasing the circumferential extent of the heat exchanger outlet relative to traditional engines, adding to the skin friction loss reduction in the bypass duct 16. Reducing the skin friction loss in this manner can have significant positive effect on thrust specific fuel consumption (TSFC).

While shown and described in the exemplary context of reducing skin friction losses on the inner wall of a bypass duct in a turbofan engine, those skilled in the art will readily appreciate that the techniques disclosed can also be used on the fan duct outer duct wall 12, along the bypass duct bifurcators, or in any other suitable application without departing from the scope of this disclosure. Also, while shown and described with specific examples of components cooled by heat exchangers, those skilled in the art will readily appreciate that any other suitable components can be connected for cooling without departing from the scope of this disclosure.

The methods and systems of the present disclosure, as described above and shown in the drawings, provide for bypass ducts with superior properties including improved flow efficiency. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A bypass duct component for a gas turbine engine comprising:
a heat exchanger outlet configured to be mounted to a bypass duct, wherein the heat exchanger outlet is configured to bathe a bypass duct surface downstream of the heat exchanger outlet with heat exchanger exhaust to reduce skin friction losses for the bypass duct.

2. A bypass duct component as recited in claim 1, wherein the heat exchanger outlet is configured to extend around a portion the bypass duct circumferentially.

3. A bypass duct component as recited in claim 1, wherein the heat exchanger outlet is configured to extend around up to 360° of the bypass duct circumferentially.

4. A bypass duct component as recited in claim 1, further comprising an inner fixed structure that is a portion of a bypass duct, wherein the heat exchanger outlet is mounted to a forward portion of the inner fixed structure.

5. A bypass duct component as recited in claim 4, wherein the heat exchanger outlet faces aft along the inner fixed structure.

6. A bypass duct component as recited in claim 1, further comprising an inner fixed structure that includes an intermediate case, wherein the heat exchanger outlet is mounted to the intermediate case.

7. An bypass duct component as recited in claim 1, wherein the heat exchanger outlet includes a series of circumferentially spaced apart cooling fins configured to extend radially outward from a surface of the inner fixed structure.

8. A gas turbine engine comprising:
a bypass duct component including a heat exchanger outlet configured to be mounted to a bypass duct, wherein the heat exchanger outlet is configured to bathe a bypass duct surface downstream of the heat exchanger outlet with heat exchanger exhaust to reduce skin friction losses for the bypass duct; and
a heat exchanger in fluid communication with the heat exchanger outlet.

9. A gas turbine engine as recited in claim 8, wherein the heat exchanger is operatively connected to cool oil for an electrical generator.

10. A gas turbine engine as recited in claim 8, wherein the heat exchanger is a first heat exchanger wherein the gas turbine engine further comprises a second heat exchanger in fluid communication with the heat exchanger outlet, wherein the first and second heat exchangers are both in fluid communication with the heat exchanger outlet to exhaust heat exchanger exhaust, and wherein the first and second heat exchangers are each operatively connected to cool separate engine components.

11. A gas turbine engine as recited in claim 10, wherein the first heat exchanger is operatively connected to cool oil for an electrical generator, and wherein the second heat exchanger is operatively connected to cool engine oil.

12. A gas turbine engine as recited in claim 10, wherein one of the first and second heat exchangers is operatively connected to cool engine oil for a geared turbo fan transmission gearbox.
